(19) United States
(12) Patent Application Publication
(10) Pub. No.: US 2012/0070038 A1
(43) Pub. Date: Mar. 22, 2012

(54) Method of Processing Image Data and Display Apparatus for Performing the Same

(76) Inventors: Kyung-Woo Kim, Cheonan-si (KR); Young-Jae Lee, Yongin-si (KR); Dong-Joon Park, Asan-si (KR)

(21) Appl. No.: 13/212,816

(22) Filed: Aug. 18, 2011

(30) Foreign Application Priority Data
Sep. 20, 2010 (KR) 2010-0092575

(51) Int. Cl. G06K 9/00

(52) U.S. Cl. 382/107

(57) ABSTRACT

In a method of processing image data, a movement of data of first and second original image frames is estimated to calculate first and second movement vectors. The first and second original frames are different from each other. A sample frame is generated using the first and second movement vectors. At least one luminance interpolation frame having an average luminance value of two image frames adjacent to each other is generated according to a result of comparing the first original image frame with the sample frame. The luminance interpolation frame is inserted between the first and second original image frames. An abnormal display quality like shaking and trembling image due to inserting a movement interpolation frame interpolated movement is reduced, so that a display quality may be enhanced.

### PRIORITY STATEMENT

This application claims priority under 35 U.S.C. §119 from Korean Patent Application No. 2010-92575, filed on Sep. 20, 2010 in the Korean Intellectual Property Office (KIPO), the contents of which are herein incorporated by reference in their entirety.

### BACKGROUND OF THE INVENTION

1. Field of the Invention

The present disclosure is directed to a method of processing image data and a display apparatus for performing the method. More particularly, the present disclosure is directed to a method of processing data for displaying an image having a high-speed frame and a display apparatus for performing the method.

2. Description of the Related Art

In general, a liquid crystal display apparatus includes a liquid crystal display panel displaying an image based on a transmissivity of a liquid crystal and a backlight assembly providing the liquid crystal display panel with light.

Liquid crystal display (LCD) apparatuses are used as monitors for laptops and desktops, and have an enhanced display quality that has extended their market. Recently, LCD apparatuses have been adapted for computer games using a video and a high resolution three-dimensional stereoscopic image.

In general, a frame rate of a signal having a frequency of about 60 Hz is converted to a frame rate having a higher frequency, such as from about 120 Hz to about 240 Hz. This frame rate is controlled to improve the video resolution. For example, a movement interpolation frame which interpolates movement is generated by interpolating and estimating movement, and is inserted between a present frame and a previous frame. A high-speed frame driving method is used to insert the movement interpolation frame.

When using the high-speed frame driving method, the chip generating the movement interpolation frame may overheat from interpolating and estimating the movement. In addition, a movement estimation error in the inserted movement interpolation frame may result in a rough, or jittery image.

### SUMMARY OF THE INVENTION

Exemplary embodiments of the present invention provide a method of processing image data to improve a display quality.

Exemplary embodiments of the present invention also provide a display apparatus for performing the method.

According to an exemplary embodiment of the present invention, there is provided a method of processing image data. In the method, first and second movement vectors are calculated by estimating data movement between differing first and second original image frames received at a first frame rate. A sample frame is generated using the first and second movement vectors. The first original image frame is compared with the sample frame to yield a movement error estimation. At least one luminance interpolation frame is generated having a luminance value that is an average of two adjacent image frames, if the movement error estimation is greater than a preset threshold. The luminance interpolation frames are inserted between the first and second original image frames, are output at a second frame rate that is greater than the first frame rate.

In an exemplary embodiment, the adjacent two image frames may be the first and second original image frames.

In an exemplary embodiment, the first and second original image frames may be received as a frame frequency of about 60 Hz, and the first and second original image frames having the luminance interpolation frame inserted therebetween may be outputted as a frame frequency of about 240 Hz.

In an exemplary embodiment, the first frame rate is about 24 Hz, and the second frame rated is about 240 Hz.

In an exemplary embodiment, at least one movement interpolation frame may be generated as a weighted average of the first and second movement vectors and inserted between the first and second original image frames. The two adjacent frames may be at least one of the first original image frame and one of the movement interpolation frames, adjacent movement interpolation frames, or one of the movement interpolation frames and the second original image frame.

In an exemplary embodiment, the movement interpolation frame and the luminance interpolation frame may be inserted with a ratio of about 1:2 or about 2:1.

In an exemplary embodiment, the movement interpolation frame and the luminance interpolation frame may be inserted with a ratio of about 4:5.

According to another exemplary embodiment of the present invention, there is provided an image processing apparatus. The image processing apparatus includes a movement estimator for calculating first and second movement vectors between differing first and second original image frames received at a first frame rate, a movement interpolator for generating a sample frame using first and second movement vectors and for generating at least one luminance interpolation frame and at least one movement interpolation frame, a mode decider for comparing the first original image frame with the sample frame to determine movement error estimation, and an output unit for inserting one or more of the luminance interpolation frame and the movement interpolation frame between the first and second original image frames, based on the movement error estimation, and for outputting the first and second original image frames and the inserted frames therebetween at a second frame rate that is greater than the first frame rate.

In an exemplary embodiment, the data processor may include a frame memory for storing the first original frame for comparison with the sample frame, and the second original frame for calculating the first and second movement vectors from the first and second original image frames.

In an exemplary embodiment, if the movement error estimation is greater than a preset threshold, the two adjacent image frames are the first and second original image frames, the movement interpolator generates the luminance interpolation frame as having a luminance value that is an average of the two adjacent image frames, and the output unit inserts the luminance interpolation frame between the first and second original image frames and outputs the original and inserted frames.

In an exemplary embodiment, if the movement error estimation is greater than a preset threshold, the movement interpolator generates at least one movement interpolation frame as a weighted average of the first and second movement vectors and generates the luminance interpolation frame as having a luminance value that is an average of the two adjacent image frames. The two adjacent frames may be least one of the first original image frame and one of the movement interpolation frames, adjacent movement interpolation frames, or one of the movement interpolation frames and the second original image frame. The output unit inserts the luminance interpolation frame and the movement interpolation frame between the first and second original image frames and outputs the original and inserted frames.

In an exemplary embodiment, if the movement error estimation is less than a preset threshold, the movement interpolator generates one or more movement interpolation frames as a weighted average of the first and second movement vectors, and the output unit inserts the movement interpolation frames between the first and second original image frames and outputs the original and inserted frames.

In an exemplary embodiment, the image processing apparatus also includes a timing controller for receiving the original and the inserted frames from the output unit, and for outputting the original and the inserted frames and a control signal, a display panel for displaying an image; and a panel driver for receiving the original and the inserted frames and control signal from the timing controller, converting the original and the inserted frames into analog format, and outputting the converted frames to the display panel.

According to another exemplary embodiment of the present invention, there is provided a method of processing image data. In the method, first and second movement vectors are calculated by estimating data movement between differing first and second original image frames received at a first frame rate. One or more movement interpolation frames are calculated as a weighted average of the first and second movement vectors. The movement interpolation frames are inserted between the first and second original image frames. The original and inserted frames are output at a second frame rate that is greater than the first frame rate.

In an exemplary embodiment, a sample frame is generated using the first and second movement vectors, and the first original image frame is compared with the sample frame to yield a movement error estimation. One or more movement interpolation frames are calculated if the movement error estimation is less than a preset threshold.

In an exemplary embodiment, if the movement error estimation is greater than a preset threshold, at least one luminance interpolation frame is generated having a luminance value that is an average of two adjacent image frames. The two adjacent frames are at least one of the first original image frame and one of the movement interpolation frames, adjacent movement interpolation frames, or one of the movement interpolation frames and the second original image frames.

According to the method of processing image data and the display apparatus for performing the method, when a movement estimation error occurs, a luminance interpolation frame having a luminance value that is an average of adjacent frames or interleaved luminance interpolation frames and the movement interpolation frames are inserted to improve abnormal display quality due to overheating and image jitter.

### BRIEF DESCRIPTION OF THE DRAWINGS

FIG. 1 is a block diagram illustrating a display apparatus according to an exemplary embodiment of the present invention.

FIG. 2 is a block diagram illustrating a data processor of FIG. 1.

FIG. 3 is a conceptual diagram for illustrating a movement interpolation method of a movement interpolator of FIG. 2.

FIG. 4 is a flowchart for illustrating a driving method of the data processor of FIG. 2;

FIG. 5 is a block diagram illustrating a data processor according to another exemplary embodiment of the present invention.

FIG. 6 is a conceptual diagram for illustrating a movement interpolation method of a movement interpolator of FIG. 5.

FIG. 7 is a flowchart for illustrating a driving method of the data processor of FIG. 5.

FIG. 8 is a block diagram illustrating a data processor according to still another exemplary embodiment of the present invention.

FIG. 9 is a conceptual diagram for illustrating a movement interpolation method of a movement interpolator of FIG. 8.

FIG. 10 is a flowchart for illustrating a driving method of the data processor of FIG. 8.

FIG. 11 is a block diagram illustrating a data processor according to still another exemplary embodiment of the present invention.

FIG. 12 is a conceptual diagram for illustrating a movement interpolation method of a movement interpolator of FIG. 11;

FIG. 13 is a flowchart for illustrating a driving method of the data processor of FIG. 11;

FIG. 14 is a block diagram illustrating a data processor according to still another exemplary embodiment of the present invention.

FIG. 15 is a conceptual diagram for illustrating a movement interpolation method of a movement interpolator of FIG. 14.

FIG. 16 is a flowchart for illustrating a driving method of the data processor of FIG. 14.

### DETAILED DESCRIPTION OF EXEMPLARY EMBODIMENTS

Hereinafter, the embodiments of the present invention will be explained in detail with reference to the accompanying drawings.

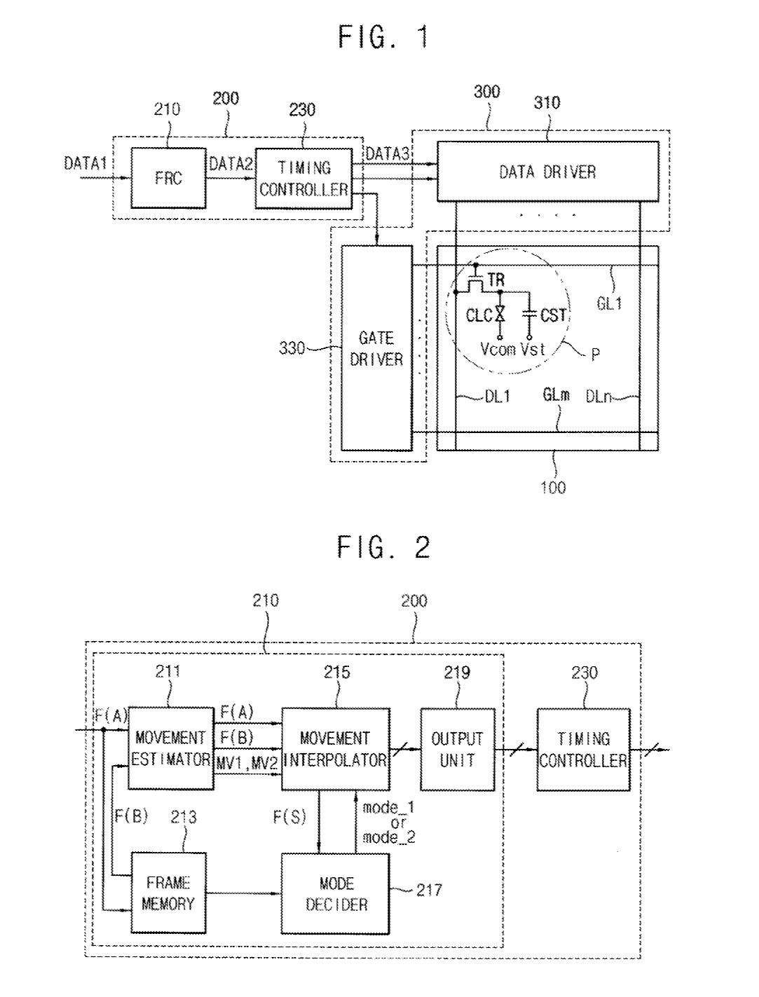

FIG. 1 is a block diagram illustrating a display apparatus according to an exemplary embodiment of the present invention.

Referring to FIG. 1, a display apparatus according to a present exemplary embodiment includes a display panel 100, a data processor 200 and a panel driver 300.

The display panel 100 includes a plurality of gate lines GL1 to GLm, a plurality of data lines DL1 to DLn and a plurality of pixels P. Each of the pixels P includes a driving element TR, a liquid crystal capacitor CLC electrically connected to the driving element TR and a storage capacitor CST. The display panel 100 may include two substrates facing each other and a liquid crystal layer disposed between the substrates.

The data processor 200 includes a frame rate controller (FRC) 210 and a timing controller 230.

The FRC 210 converts a first frame frequency of an input image DATA1 received from an external apparatus to a second frame frequency higher than the first frame frequency. Here, the first frame frequency may be about 60 Hz, and the second frame frequency may be about 240 Hz. The FRC 210 uses first and second movement vectors estimated from data movement of differing first and second original image frames to generate a sample frame. The FRC 210 generates at least one luminance interpolation frame having a luminance value that is an average luminance of two adjacent image frames according to a result of comparing the first original image frame with the sample frame. The FRC 210 may insert the luminance interpolation frame between the first and second original image frames to change a frame rate of the input image.

The timing controller 230 receives frame rate conversion data DATA2 from the data processor 200, and outputs the frame rate conversion data DATA3 to the panel driver 300 through a horizontal line unit. In addition, the timing controller 230 uses a control signal received from an external device to generate a control signal for controlling a driving timing of the panel driver 300.

The panel driver 300 may include a data driver 310 and a gate driver 330.

The data driver 310 converts data DATA3 received from the timing controller 230 to an analog data voltage. The data driver 310 outputs the data voltage to the data lines DL1 to DLn.

The gate driver 330 is synchronized with an output of the data driver 310 to output gate signals to the gate lines GL1 to GLm.

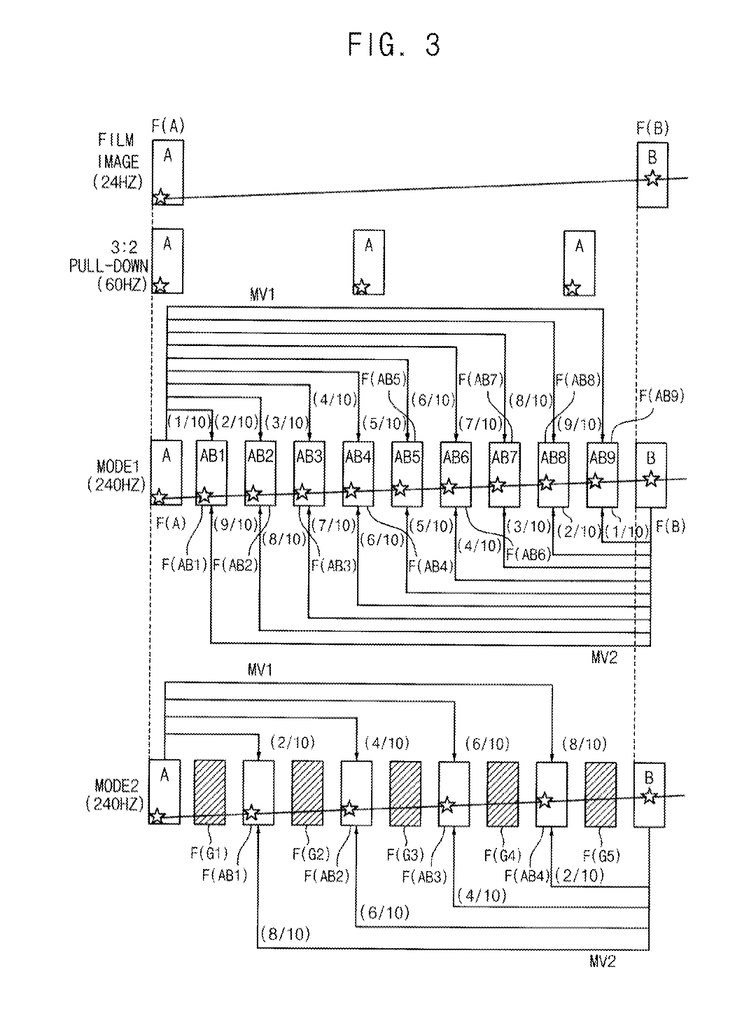

FIG. 2 is a block diagram illustrating a data processor of FIG. 1. FIG. 3 is a conceptual diagram for illustrating a movement interpolation method of a movement interpolator of FIG. 2.

Referring to FIGS. 1 to 3, the data processor 200 includes the FRC 210 and the timing controller 230. The FRC 210 may include a movement estimator 211, a frame memory 213, a movement interpolator 215, a mode decider 217 and an output unit 219.

The movement estimator 211 uses data F(A) of the first original image frame received from the external device and data F(B) of the second original image frame received from the frame memory 213 to calculate first and second movement vectors MV1 and MV2. Here, the first movement vector MV1 is calculated by considering a change of the second original image frame F(B) with respect to the first original image frame F(A). The second movement vector MV2 is calculated by considering a change of the first original image frame F(A) with respect to the second original image frame F(B). The first and second movement vectors MV1 and MV2 have substantially the same magnitude but different directions. The movement estimator 211 may estimate movement of a block unit using a block matching algorithm (BMA). Alternatively, the movement estimator 211 may estimate movement of a pixel unit using a pixel recursive algorithm (PRA). Block matching algorithms and pixel recursive algorithms are known in the art and further explanation of these algorithms will be omitted.

The mode decider 217 determines whether the movement interpolator 215 is to be operated in a first interpolating mode MODE1 or a second interpolating mode MODE2. The first interpolating mode MODE1 generates a plurality of movement interpolation frames by applying weights to the first and second movement vectors MV1 and MV2. The second interpolating mode MODE2 generates both movement interpolation frames and luminance interpolation frames. The luminance interpolation frames have a luminance value that is an average of two adjacent frames adjacent.

As shown in FIG. 3, when film image data is received, the film image data has a frame frequency of about 24 Hz. The frame frequency of the film image is pulled down to 3:2 by an external control device (not shown) to be converted into a frame frequency of about 60 Hz. The movement interpolator 215 receives image frames converted into the 60 Hz frame frequency. A method of pulling the frame frequency down to 3:2 includes generating five fields from two original image frames. For example, three fields are generated from the first original image frame, and two fields are generated from the second original image frame. The FRC 210 may compare the received image frames to determine whether the image frame is a film image having a 60 Hz frame frequency or a video image having a 60 Hz frame frequency.

When the movement interpolator 215 receives a first interpolating mode signal mode_1 from the mode decider 217, the movement interpolator 215 generates first, second, third, fourth, fifth, sixth, seventh, eighth and ninth movement interpolation frames F(AB1), F(AB2), F(AB3), F(AB4), F(AB5), F(AB6), F(AB7), F(AB8) and F(AB9) as weighted averages of the first and second movement vectors MV1 and MV2.

For example, the first movement interpolation frame F(AB1) may be generated by applying a weight of 1/10 to the first movement vector MV1 and a weight of 9/10 to the second movement vector MV2. The second movement interpolation frame F(AB2) may be generated by applying a weight of 2/10 to the first movement vector MV1 and a weight of 8/10 to the second movement vector MV2. The third movement interpolation frame F(AB3) may be generated by applying a weight of 3/10 to the first movement vector MV1 and a weight of 7/10 to the second movement vector MV2. The fourth movement interpolation frame F(AB4) may be generated by applying a weight of 4/10 to the first movement vector MV1 and a weight of 6/10 to the second movement vector MV2. The fifth movement interpolation frame F(AB5) may be generated by applying a weight of 5/10 to the first movement vector MV1 and a weight of 5/10 to the second movement vector MV2. The sixth movement interpolation frame F(AB6) may be generated by applying a weight of 6/10 to the first movement vector MV1 and a weight of 4/10 to the second movement vector MV2. The seventh movement interpolation frame F(AB7) may be generated by applying a weight of 7/10 to the first movement vector MV1 and a weight of 3/10 to the second movement vector MV2. The eighth movement interpolation frame F(AB8) may be generated by applying a weight of 8/10 to the first movement vector MV1 and a weight of 2/10 to the second movement vector MV2. The ninth movement interpolation frame F(AB9) may be generated by applying a weight of 9/10 to the first movement vector MV1 and a weight of 1/10 to the second movement vector MV2.

When the movement interpolator 215 receives a second interpolating mode signal mode_2 from the mode decider 217, the movement interpolator 215 generates first, second, third and fourth movement interpolation frames F(AB1), F(AB2), F(AB3) and F(AB4) as weighted averages of the first and second movement vectors MV1 and MV2. For example, the first movement interpolation frame F(AB1) may be generated by applying a weight of 2/10 to the first movement vector MV1 and a weight of 8/10 to the second movement vector MV2. The second movement interpolation frame F(AB2) may be generated by applying a weight of 4/10 to the first movement vector MV1 and a weight of 6/10 to the second movement vector MV2. The third movement interpolation frame F(AB3) may be generated by applying a weight of 6/10 to the first movement vector MV1 and a weight of 4/10 to the second movement vector MV2. The fourth movement interpolation frame F(AB4) may be generated by applying a weight of 8/10 to the first movement vector MV1 and a weight of 2/10 to the second movement vector MV2.

While in the second interpolating mode MODE2, the movement interpolator 215 generates first, second, third, fourth and fifth luminance interpolation frames F(G1), F(G2), F(G3), F(G4) and F(G5) using the first and second original image frames F(A) and F(B) and the first to fourth movement interpolation frames F(AB1) to F(AB4). Each of the first to fifth luminance interpolation frames F(G1) to F(G5) may have a luminance value that is an average of two adjacent frames.

For example, the first luminance interpolation frame F(G1) may have a luminance value that is an average of the first original image frame F(A) and the first movement interpolation frame F(AB1), and may be inserted between the first original image frame F(A) and the first movement interpolation frame F(AB1). The second interpolation frame F(G2) may have a luminance value that is an average of the first and second movement interpolation frames F(AB1) and F(AB2), and may be inserted between the first and second movement interpolation frames F(AB1) and F(AB2). The third interpolation frame F(G3) may have a luminance value that is an average of the second and third movement interpolation frames F(AB2) and F(AB3), and may be inserted between the second and third movement interpolation frames F(AB2) and F(AB3). The fourth interpolation frame F(G4) may have a luminance value that is an average of the third and fourth movement interpolation frames F(AB3) and F(AB4), and may be inserted between the third and fourth movement interpolation frames F(AB3) and F(AB4). The fifth interpolation frame F(G5) may have a luminance value that is an average of the fourth movement interpolation frame F(AB4) and the second original image frame F(B), and may be inserted between the fourth movement interpolation frame F(AB4) and the second original image frame F(B).

The mode decider 217 may detect a movement estimation error and may output either the first or second interpolating mode signal mode_1 or mode_2 to the movement interpolator 215 depending on whether the movement estimation error is greater than a preset threshold. The movement estimation error may be detected by comparing sample frame data F(S) with the first original image frame data F(A). Here, the sample frame may be the first movement interpolation frame F(AB1). When the movement estimation error is less than the threshold, the mode decider 217 outputs the first interpolating mode signal mode_1 to the movement interpolator 215. However, when the movement estimation error is greater than the threshold, the mode decider 217 outputs the second interpolating mode signal mode_2 to the movement interpolator 215.

The output unit 219 inserts the first to ninth movement interpolation frames F(AB1) to F(AB9) or the first to fourth movement interpolation frames F(AB1) to F(AB4) and the first to fifth luminance interpolation frames F(G1) to F(G5) between the first and second original image frames F(A) and F(B) and outputs the first and second original image frames F(A) and F(B) with the inserted frames in between.

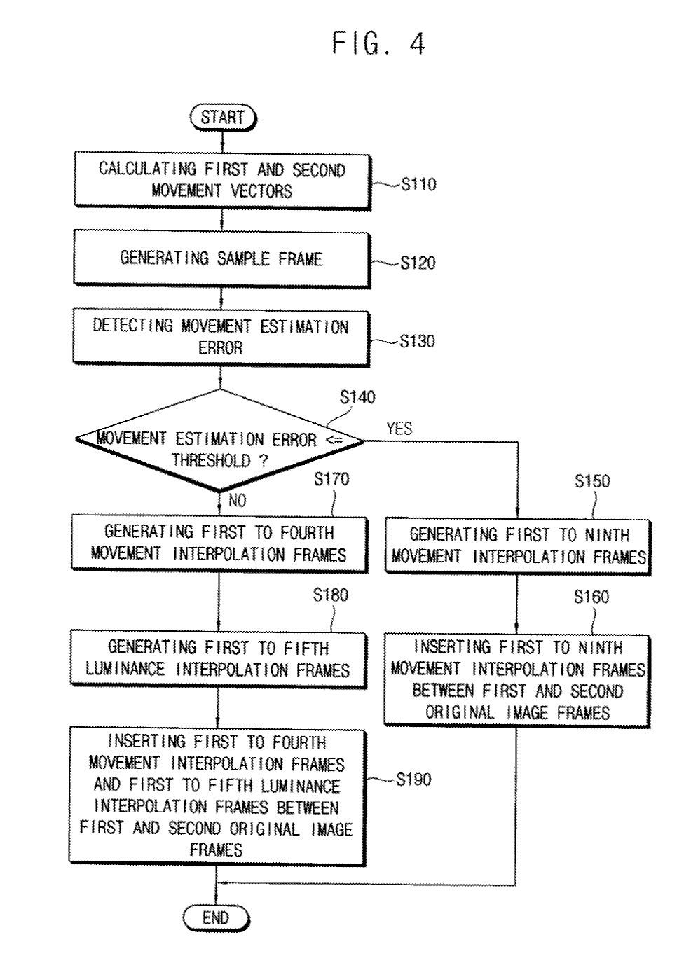

FIG. 4 is a flowchart for explaining a driving method of the data processor of FIG. 2.

Referring to FIGS. 2 to 4, when frame data corresponding to a film image are received from an external device, the movement estimator 211 compares the data of the first and second original image frames F(A) and F(B).

The movement estimator 211 estimates data movement between the first and second original image frames F(A) and F(B) to calculate the first and second movement vectors MV1 and MV2 (step S110).

The movement interpolator 215 generates a sample frame as a weighted average of the first and second movement vectors MV1 and MV2 (step S120). The movement interpolator 215 outputs data F(S) of the sample frame to the mode decider 217.

The mode decider 217 compares the sample frame data F(S) received from the movement interpolator 215 with the first original image frame data F(A) stored at the frame memory 213 to determine the movement estimation error (step S130).

The mode decider 217 determines whether the movement estimation error is larger than the threshold (step S140). When the movement estimation error is less than the threshold, the mode decider 217 outputs the first interpolating mode signal mode _1 to the movement interpolator 215.

The movement interpolator 215 receiving the first interpolating mode signal mode_1 generates the first to ninth movement interpolation frames F(AB1) to F(AB9) as a weighted average of the first and second movement vectors MV1 and MV2 (step S150).

The output unit 219 inserts the first to ninth movement interpolation frames F(AB1) to F(AB9) between the first and second original image frames F(A) and F(B) and outputs the original and the inserted frames to the timing controller 230 (step S160).

When the movement estimation error is greater than the threshold, the mode decider 217 outputs the second interpolating mode signal mode_2 to the movement interpolator 215.

The movement interpolator 215 receiving the second interpolating mode signal mode_2 generates the first to fourth movement interpolation frames F(AB1) to F(AB4) as a weighted average of the first and second movement vectors MV1 and MV2 (step S170).

The movement interpolator 215 generates the first to fifth luminance interpolation frames F(G1) to F(G5) using the first and second original image frames F(A) and F(B) and the first to fourth movement interpolation frames F(AB1) to F(AB4) (step S180).

The output unit 219 sequentially inserts the first luminance interpolation frame F(G1), the first movement interpolation frame F(AB1), the second luminance interpolation frame F(G2), the second movement interpolation frame F(AB2), the third luminance interpolation frame F(G3), the third movement interpolation frame F(AB3), the fourth luminance interpolation frame F(G4), the fourth movement interpolation frame F(AB4) and the fifth luminance interpolation frame F(G5) between the first and second original image frames F(A) and F(B) and outputs the original frames and the inserted frames to the timing controller 230 (step S190).

According to a present exemplary embodiment, when the movement estimation error is greater than a threshold, the movement interpolation frame and the luminance interpolation frame are inserted between the first and second original image frames F(A) and FA(B) with about a 4:5 ratio. Thus, the movement interpolator 215 performs fewer calculations as compared with a device inserting only the movement interpolation frames between the first and second original image frames F(A) and F(B), reducing the heat generated by the FRC 210.

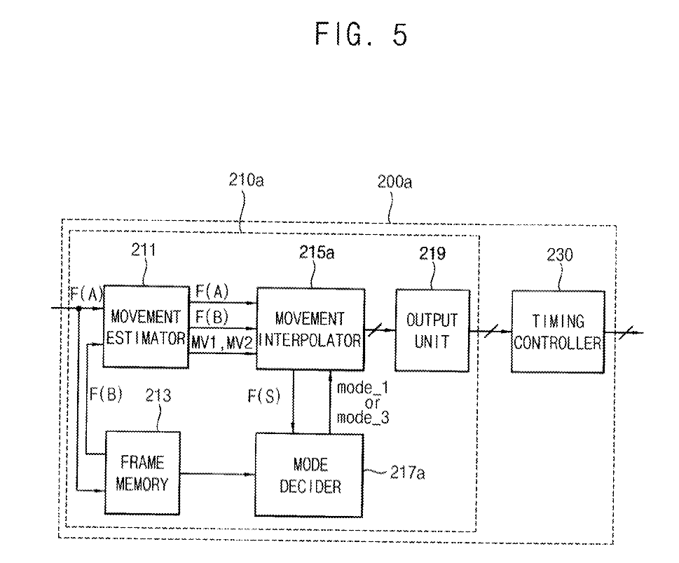

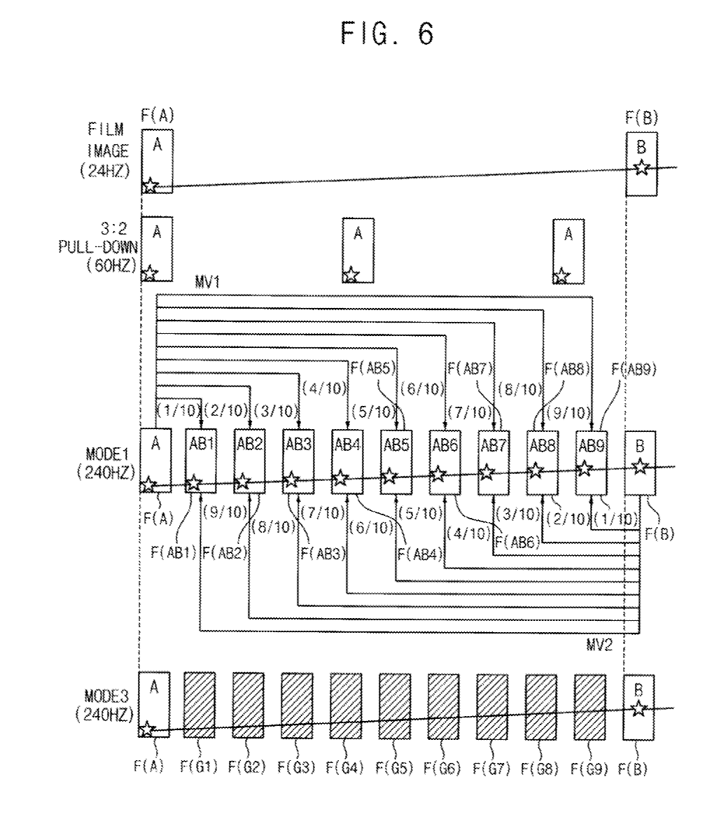

FIG. 5 is a block diagram illustrating a data processor according to another exemplary embodiment of the present invention. FIG. 6 is a conceptual diagram for illustrating a movement interpolation method of a movement interpolator of FIG. 5.

A display apparatus according to a present exemplary embodiment is substantially the same as a display apparatus according to a previous exemplary embodiment described referring to FIGS. 1 to 4 except for a data processor 200a. In addition, the data processor 200a according to a present exemplary embodiment is substantially the same as the data processor 200 according to a previous exemplary embodiment described referring to FIGS. 1 to 4 except for a movement interpolator 215a and a mode decider 217a. Thus, the same reference numerals will be used to refer to the same or like parts as those described in a previous exemplary embodiment and thus any repetitive explanation concerning the above elements will be omitted or briefly described.

Referring to FIGS. 5 and 6, the data processor 200a includes an FRC 210a and a timing controller 230. The FRC 210a includes a movement estimator 211, a frame memory 213, a movement interpolator 215a, a mode decider 217a and an output unit 219.

The mode decider 217a determines whether a movement estimation error is greater than a preset threshold, and determines an interpolating mode of the movement interpolator 215a depending on whether the movement estimation error is greater than a preset threshold. For example, when the movement estimation error is less than the threshold, the mode decider 217a outputs a first interpolating mode signal mode_1 to the movement interpolator 215a. However, when the movement estimation error is greater than the threshold, the mode decider 217a outputs a third interpolating mode signal mode_3 to the movement interpolator 215a. The first interpolating mode MODE1 as shown in FIG. 6 inserts first to ninth movement interpolation frames F(AB1) to F(AB9) between first and second original image frames F(A) and F(B). The first to ninth movement interpolation frames F(AB1) to F(AB9) are generated as a weighted average of first and second movement vectors MV1 and MV2 calculated by the movement estimator 211. A method of generating the first to ninth movement interpolation frames F(AB1) to F(AB9) is substantially the same as the method explained with reference to FIG. 3, so that repetitive explanation will be omitted. The third interpolating mode MODE3 inserts first to ninth luminance interpolation frames F(G1) to F(G9) between the first and second original image frames F(A) and F(B). The first to ninth luminance interpolation frames F(G1) to F(G9) may have luminance values that are averages of the first and second original image frames F(A) and F(B).

When the movement interpolator 215a receives the first interpolating mode signal mode_1 from the mode decider 217a, the movement interpolator 215a generates the first to ninth movement interpolation frames F(AB1) to F(AB9) as a weighted average of the first and second movement vectors MV1 and MV2. When the movement interpolator 215a receives the third interpolating mode signal mode_3 from the mode decider 217a, the movement interpolator 215a generates the first to ninth luminance interpolation frames F(G1) to F(G9) having a luminance value that is an average of the first and second original image frames F(A) and F(B).

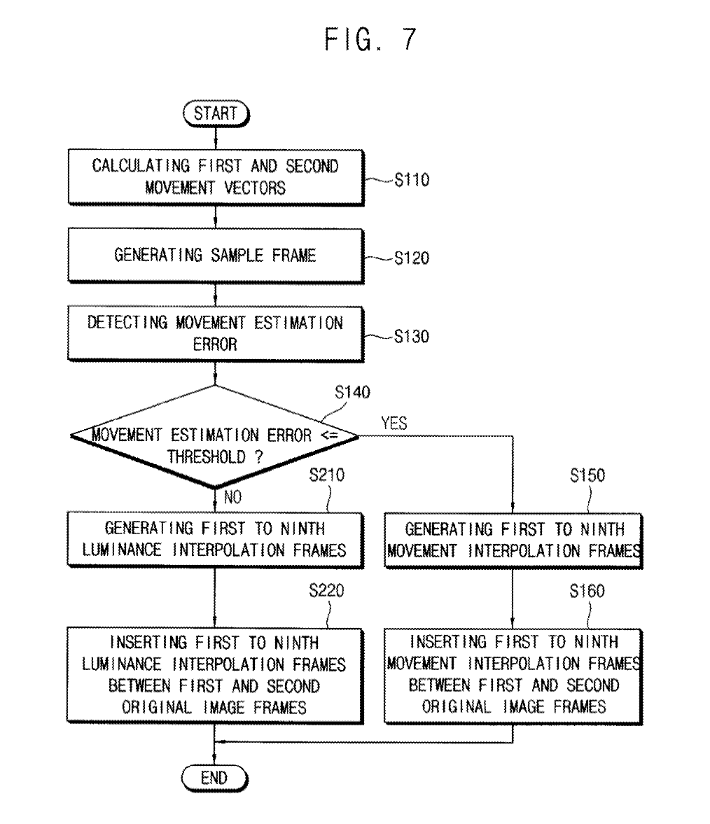

FIG. 7 is a flowchart for illustrating a driving method of the data processor of FIG. 5.

A method of driving the data processor 200a according to a present exemplary embodiment is substantially the same as a method of driving the data processor 200 according to a previous exemplary embodiment described with reference to FIGS. 1 to 4 except for step S210 and step S220, which replace steps S170, S180 and S190, so that the same reference numerals will be used to refer to the same or like steps as those described in a previous exemplary embodiment and thus any repetitive explanation concerning the above elements will be omitted or briefly described.

Referring to FIGS. 5 to 7, when the movement estimation error is greater than the threshold, the mode decider 217a outputs the third interpolating mode signal mode_3 to the movement interpolator 215a.

When the movement interpolator 215a receives the third interpolating mode signal mode_3, the movement interpolator 215a generates the first to ninth luminance interpolation frames F(G1) to F(G9) using the first and second original image frames F(A) and F(B) (step S210). The first to ninth luminance interpolation frames F(G1) to F(G9) have a luminance value that is an average of the first and second original image frames F(A) and F(B).

The output unit 219 inserts the first to ninth luminance interpolation frames F(G1) to F(G9) between the first and second original image frames F(A) and F(B) and outputs the original frames and the inserted frames (step S 220).

According to a present exemplary embodiment, the movement interpolator 215a performs fewer calculations as compared with a previous exemplary embodiment described with reference to FIGS. 1 to 4 in which movement interpolation frames and luminance interpolation frame are inserted with about a 4:5 ratio, preventing overheating of the FRC 210a. In addition, the display of rough and jittery images caused by inserting an erroneous movement interpolation frame may be prevented.

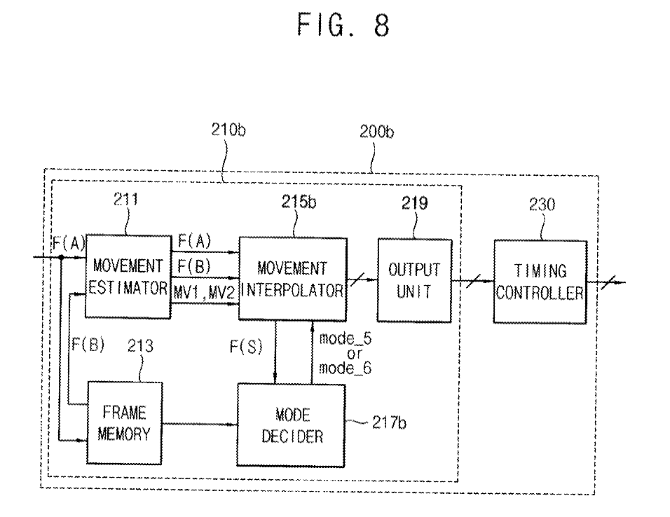

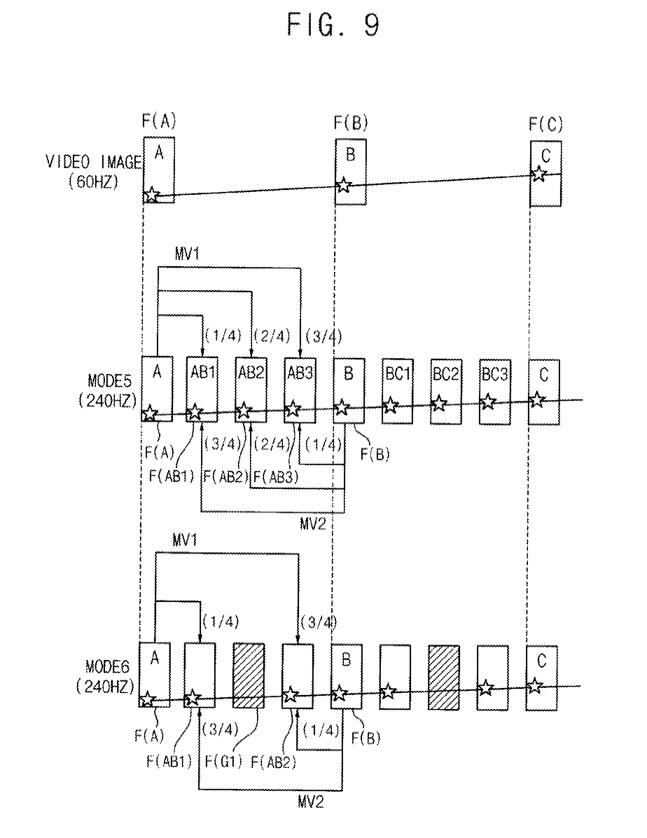

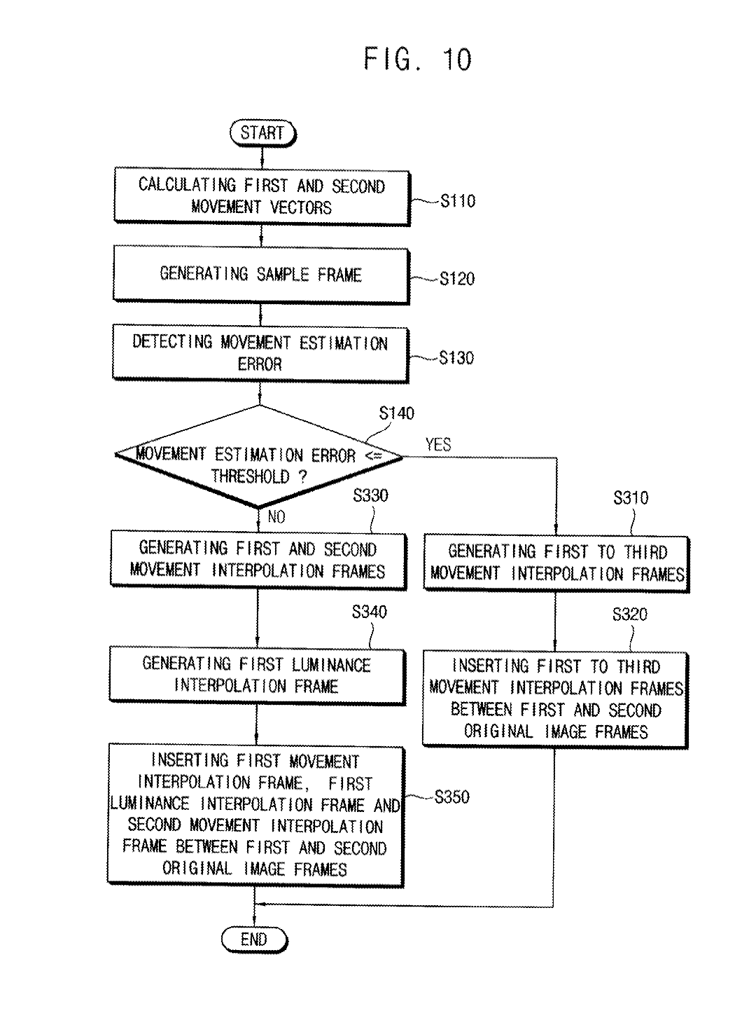

FIG. 8 is a block diagram illustrating a data processor according to still another exemplary embodiment of the present invention. FIG. 9 is a conceptual diagram for illustrating a movement interpolation method of a movement interpolator of FIG. 8.

A display apparatus according to a present exemplary embodiment is substantially the same as a display apparatus according to a previous exemplary embodiment described with reference to FIGS. 1 to 4 except for a data processor 200b. In addition, the data processor 200b according to a present exemplary embodiment is substantially the same as the data processor 200 according to a previous exemplary embodiment described with reference to FIGS. 1 to 4 except for a movement interpolator 215b and a mode decider 217b. Thus, the same reference numerals will be used to refer to the same or like parts as those described in a previous exemplary embodiment and thus any repetitive explanation concerning the above elements will be omitted or briefly described.

Referring to FIGS. 8 and 9, the data processor 200b includes an FRC 210b and a timing controller 230. The FRC 210b receives a video image having a frame frequency of about 60 Hz. The FRC 210b outputs the video image having a frame frequency of about 240 Hz. The FRC 210b includes a movement estimator 211, a frame memory 213, a movement interpolator 215b, a mode decider 217b and an output unit 219.

The mode decider 217b determines a movement interpolating mode of the movement interpolator 215b depending on whether a movement estimation error of the movement estimator 211 is greater than a preset threshold. For example, when the movement estimation error is less than the threshold, the mode decider 217b outputs a fifth interpolating mode signal mode_5 to the movement interpolator 215b. When the movement estimation error is greater than the threshold, the mode decider 217b outputs a sixth interpolating mode signal mode_6 to the movement interpolator 215b. A fifth interpolating mode MODES inserts first to third movement interpolation frames F(AB1) to F(AB3) between first and second original image frames F(A) and F(B). A sixth interpolating mode MODE6 inserts first and second movement interpolation frames F(AB1) and F(AB2) and a first luminance interpolation frame F(G1) between the first and second original image frames F(A) and F(B).

The movement interpolator 215b receives the first and second original image frames F(A) and F(B) of a video image having a frame frequency of about 60 Hz. When the movement interpolator 215b receives the fifth interpolating mode signal mode_5 from the mode decider 217b, the movement interpolator 215b generates the first to third movement interpolation frames F(AB1) to F(AB3) as a weighted average of first and second movement vectors MV1 and MV2 calculated by the movement estimator 211. For example, the first movement interpolation frame F(AB1) may be generated by applying a weight of 1/4 to the first movement vector MV1 and a weight of 3/4 to the second movement vector MV2. The second movement interpolation frame F(AB2) may be generated by applying a weight of 2/4 to the first movement vector MV 1 and a weight of 2/4 to the second movement vector MV2. The third movement interpolation frame F(AB3) may be generated by applying a weight of 3/4 to the first movement vector MV1 and a weight of 1/4 to the second movement vector MV2. The output unit 219 inserts the first to third movement interpolation frames F(AB1) to F(AB3) between the first and second original image frames F(A) and F(B) and outputs frame data at a frame frequency of about 240 Hz.

When the movement interpolator 215b receives the sixth interpolating mode signal mode_6 from the mode decider 217b, the movement interpolator 215b generates the first and second movement interpolation frames F(AB1) and F(AB2) using the first and second movement vectors MV1 and MV2. For example, the first movement interpolation frame F(AB1) may be generated by applying a weight of 1/4 to the first movement vector MV1 and a weight of 3/4 to the second movement vector MV2. The second movement interpolation frame F(AB2) may be generated by applying a weight of 3/4 to the first movement vector MV1 and a weight of 1/4 to the second movement vector MV2.

While in the sixth interpolating mode MODE6, the movement interpolator 215b generates the first luminance interpolation frame F(G1) using the first and second movement vectors MV1 and MV2. The first luminance interpolation frame F(G1) is inserted between the first and second movement interpolation frames F(AB1) and F(AB2) and may have a luminance value that is an average of the first and second movement interpolation frames F(AB1) and F(AB2).

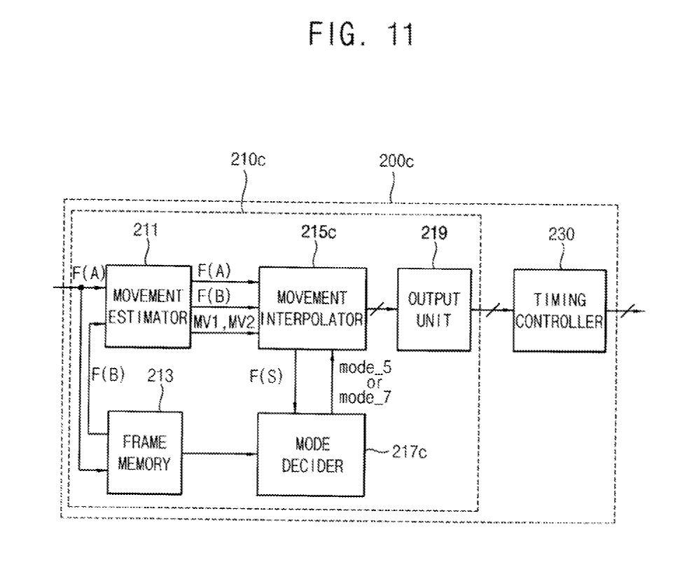

FIG. 10 is a flowchart for explaining a driving method of the data processor of FIG. 8.

A method of driving the data processor 200b according to a present exemplary embodiment is substantially the same as a method of driving the data processor 200 according to a previous exemplary embodiment described with reference to FIGS. 1 to 4 except for steps S310 to S350, which replace steps S150 to S190, so that the same reference numerals will be used to refer to the same or like steps as those described in a previous exemplary embodiment and thus any repetitive explanation concerning the above elements will be omitted or briefly described.

Referring to FIGS. 8 to 10, when the movement estimation error is less than the threshold, the mode decider 217b outputs the fifth interpolating mode signal mode_5.

When the movement interpolator 215b receives the fifth interpolating mode signal mode_5, the movement interpolator 215b generates the first to third movement interpolation frames F(AB1) to F(AB3) using the first and second movement vectors MV1 and MV2 (step S310).

The output unit 219 inserts the first to third movement interpolation frames F(AB1) to F(AB3) between the first and second original image frames F(A) and F(B) and outputs the original and inserted frames (step S320).

When the movement estimation error is greater than the threshold, the mode decider 217b outputs the sixth interpolating mode signal mode_6.

When the movement interpolator 215b receives the sixth interpolating mode signal mode_6, the movement interpolator 215b generates the first and second movement interpolation frames F(AB1) and F(AB2) using the first and second movement vectors MV1 and MV2 (step S330).

The movement interpolator 215b generates the first luminance interpolation frame F(G1) having a luminance value that is an average of the first and second movement interpolation frames F(AB2) and F(AB2) (step S340). The first luminance interpolation frame F(G1) is inserted between the first and second movement interpolation frames F(AB2) and F(AB2).

The output unit 219 sequentially inserts the first movement interpolation frame F(AB1), the first luminance interpolation frame F(G1) and the second movement interpolation frame F(AB2) between the first and second original image frames F(A) and F(B) and outputs the original frames and the inserted frames (step S350). As shown in FIG. 9, the first luminance interpolation frame F(G1) and the first and second movement interpolation frames F(AB2) and F(AB2) may be inserted with about a 1:2 ratio.

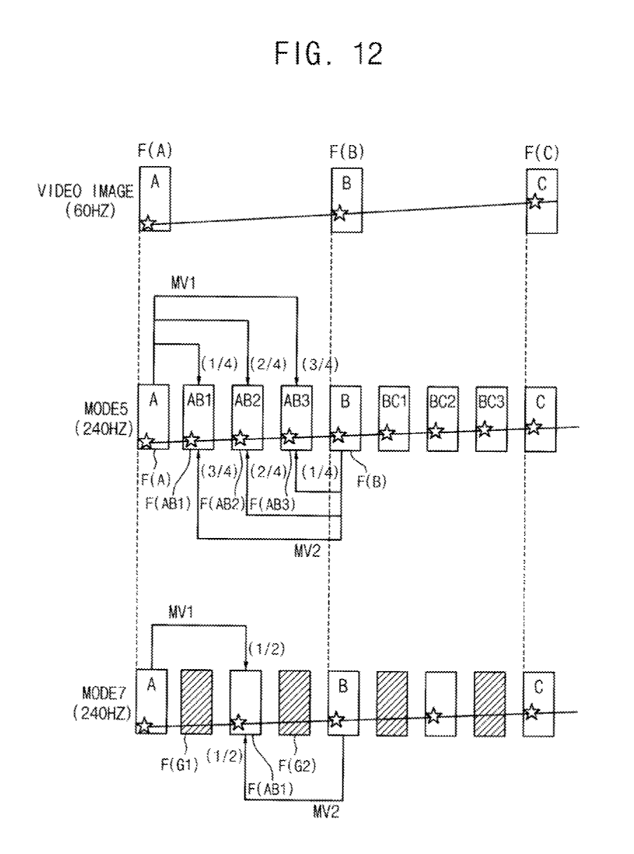

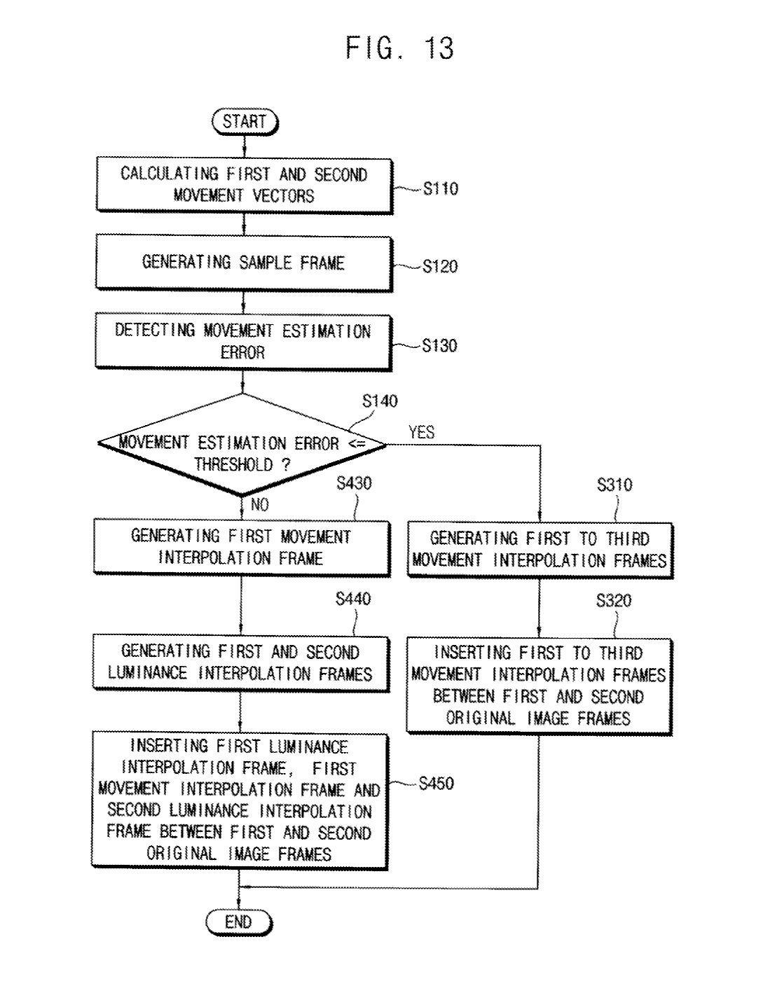

FIG. 11 is a block diagram illustrating a data processor according to still another exemplary embodiment of the present invention. FIG. 12 is a conceptual diagram for illustrating a movement interpolation method of a movement interpolator of FIG. 11.

A display apparatus according to a present exemplary embodiment is substantially the same as a display apparatus according to a previous exemplary embodiment described with reference to FIGS. 1 to 4 except for a data processor 200c. In addition, the data processor 200c according to a present exemplary embodiment is substantially the same as the data processor 200 according to a previous exemplary embodiment described with reference to FIGS. 1 to 4 except for a movement interpolator 215c and a mode decider 217c. Thus, the same reference numerals will be used to refer to the same or like parts as those described in a previous exemplary embodiment and thus any repetitive explanation concerning the above elements will be omitted or briefly described.

Referring to FIGS. 11 and 12, the data processor 200c includes an FRC 210c and a timing controller 230. The FRC 210c receives a video image having a frame frequency of about 60 Hz. The FRC 210c outputs the video image having a frame frequency of about 240 Hz. The FRC 210c includes a movement estimator 211, a frame memory 213, a movement interpolator 215c, a mode decider 217c and an output unit 219.

The mode decider 217c determines a movement interpolating mode of the movement interpolator 215c depending on whether the movement estimation error of the movement estimator 211 is greater than a preset threshold. For example, when the movement estimation error is less than the threshold, the mode decider 217c outputs a fifth interpolating mode signal mode_5 to the movement interpolator 215c. When the movement estimation error is greater than the threshold, the mode decider 217c outputs a seventh interpolating mode signal mode_7 to the movement interpolator 215c. A fifth interpolating mode MODES as shown in FIG. 12, inserts first to third movement interpolation frames F(AB1) to F(AB3) between first and second original image frames F(A) and F(B). The first to third movement interpolation frames F(AB1) to F(AB3) are generated as a weighted average of first and second movement vectors MV1 and MV2 calculated by the movement estimator 211. A seventh interpolating mode MODE7 inserts first movement interpolation frame F(AB1) and first and second luminance interpolation frames F(G1) and F(G2) between the first and second original image frames F(A) and F(B).

When the movement interpolator 215c receives the fifth interpolating mode signal mode_5 from the mode decider 217c, the movement interpolator 215c generates the first to third movement interpolation frames F(AB1) to F(AB3) as a weighted average of the first and second movement vectors MV1 and MV2. A method of generating the first to third movement interpolation frames F(AB1) to F(AB3) is substantially the same as a method explained with reference to FIG. 9, so that repetitive explanation will be omitted.

When the movement interpolator 215c receives the seventh interpolating mode signal mode_7 from the mode decider 217c, the movement interpolator 215c generates the first movement interpolation frame F(AB1) using the first and second movement vectors MV1 and MV2. The first movement interpolation frame F(AB1) may be generated by applying a weight of 1/2 to the first movement vector MV1 and a weight of 1/2 to the second movement vector MV2.

The movement interpolator 215c generates the first and second luminance interpolation frames F(G1) and F(G2) using the first and second original image frames F(A) and F(B) and the first movement interpolation frame F(AB1). The first luminance interpolation frame F(G1) is inserted between the first original image frame F(A) and the first movement interpolation frame F(AB1). The first luminance interpolation frame F(G1) may have an luminance value that is an average of the first original image frame F(A) and the first movement interpolation frame F(AB1). The second luminance interpolation frame F(G2) is inserted between the first movement interpolation frame F(AB1) and the second original image frame F(B). The second luminance interpolation frame F(G2) may have an luminance value that is an average of the first movement interpolation frame F(AB1) and the second original image frame F(B).

FIG. 13 is a flowchart for illustrating a driving of the data processor of FIG. 11.

A method of driving the data processor 200c according to a present exemplary embodiment is substantially the same as a method of driving the data processor 200 according to a previous exemplary embodiment described with reference to FIGS. 8 to 10 except for steps S430 to S450, which replace steps 330 to 350, so that the same reference numerals will be used to refer to the same or like steps as those described in a previous exemplary embodiment and thus any repetitive explanation concerning the above elements will be omitted or briefly described.

Referring to FIGS. 11 to 13, when the movement estimation error is greater than the threshold, the mode decider 217c outputs the seventh interpolating mode signal mode_7.

When the movement interpolator 215c receives the seventh interpolating mode signal mode-7, the movement interpolator 215c generates the first movement interpolation frame F(AB1) using the first and second movement vectors MV1 and MV2 (step S430).

The movement interpolator 215c generates the first and second luminance interpolation frames F(G1) and F(G2) using the first and second original image frames F(A) and F(B) and the first movement interpolation frame F(AB1) (step S440).

The output unit 219 sequentially inserts the first luminance interpolation frame F(G1), the first movement interpolation frame F(AB1) and the second luminance interpolation frame F(G2) between the first and second original image frames F(A) and F(B) and outputs the original frames and the inserted frames (step S450).

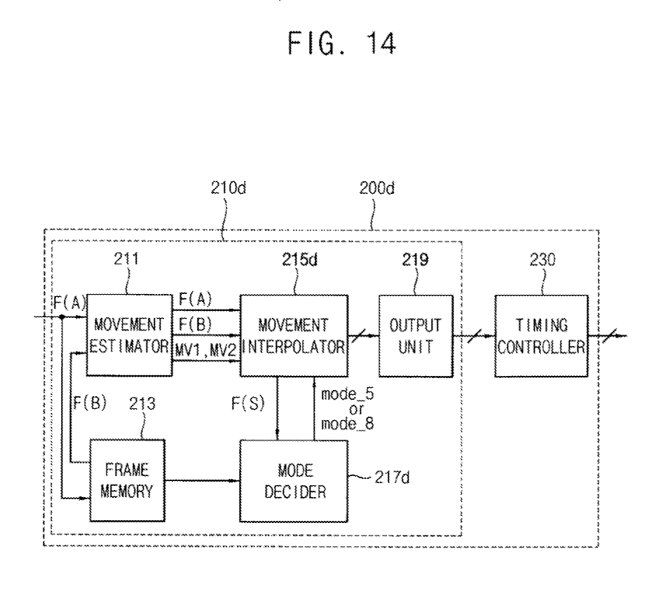

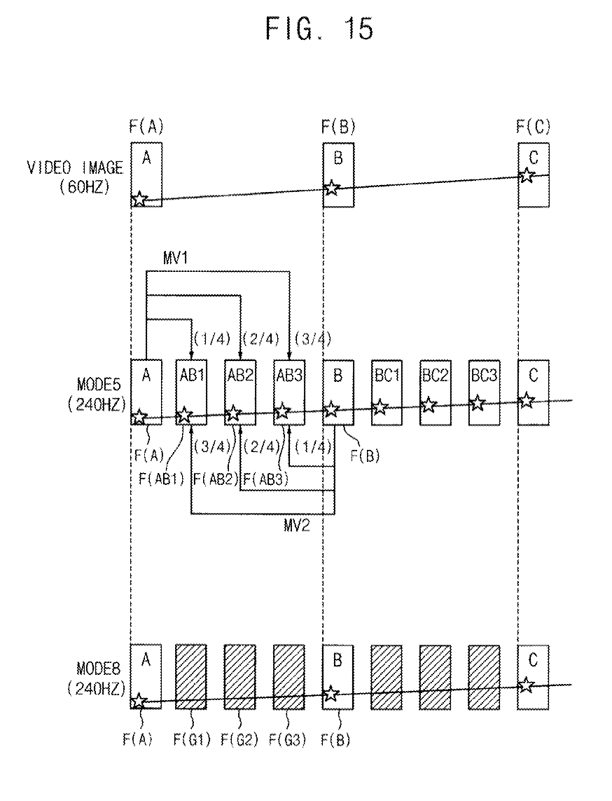

FIG. 14 is a block diagram illustrating a data processor according to still another exemplary embodiment of the present invention. FIG. 15 is a conceptual diagram for illustrating a movement interpolation method of a movement interpolator of FIG. 14.

A display apparatus according to a present exemplary embodiment is substantially the same as a display apparatus according to a previous exemplary embodiment described with reference to FIGS. 1 to 4 except for a data processor 200d. In addition, the data processor 200d according to a present exemplary embodiment is substantially the same as the data processor 200 according to a previous exemplary embodiment described with reference to FIGS. 1 to 4 except for a movement interpolator 215d and a mode decider 217d. Thus, the same reference numerals will be used to refer to the same or like parts as those described in a previous exemplary embodiment and thus any repetitive explanation concerning the above elements will be omitted or briefly described.

Referring to FIGS. 14 and 15, the data processor 200d includes an FRC 210d and a timing controller 230. The FRC 210d receives a video image having about a 60 Hz frame frequency. The FRC 210d outputs the video image having about a 240 Hz frame frequency. The FRC 210d includes a movement estimator 211, a frame memory 213, a movement interpolator 215d, a mode decider 217d and an output unit 219.

The mode decider 217d determines whether a movement estimation error is greater than a preset threshold, and determines a movement interpolating mode of the movement interpolator 215d depending on whether the movement estimation error is greater than the preset threshold. For example, when the movement estimation error is less than the threshold, the mode decider 217d outputs a fifth interpolating mode signal mode_5 to the movement interpolator 215d. When the movement estimation error is greater than the threshold, the mode decider 217d outputs an eighth interpolating mode signal mode_8 to the movement interpolator 215d. A fifth interpolating mode MODE5 as shown in FIG. 15, inserts first to third movement interpolation frames F(AB1) to F(AB3) between first and second original image frames F(A) and F(B). The first to third movement interpolation frames F(AB1) to F(AB3) are generated as a weighted average of first and second movement vectors MV1 and MV2 calculated by the movement estimator 211. A method of generating the first to third movement interpolation frames F(AB1) to F(AB3) is substantially the same as a method explained with reference to FIG. 9, so that repetitive explanation will be omitted. An eighth interpolating mode MODE8 inserts first to third luminance interpolation frames F(G1) to F(G3) between the first and second original image frames F(A) and F(B). The first to third luminance interpolation frames F(G1) to F(G3) may have an luminance value that is an average of the first and second original image frames F(A) and F(B).

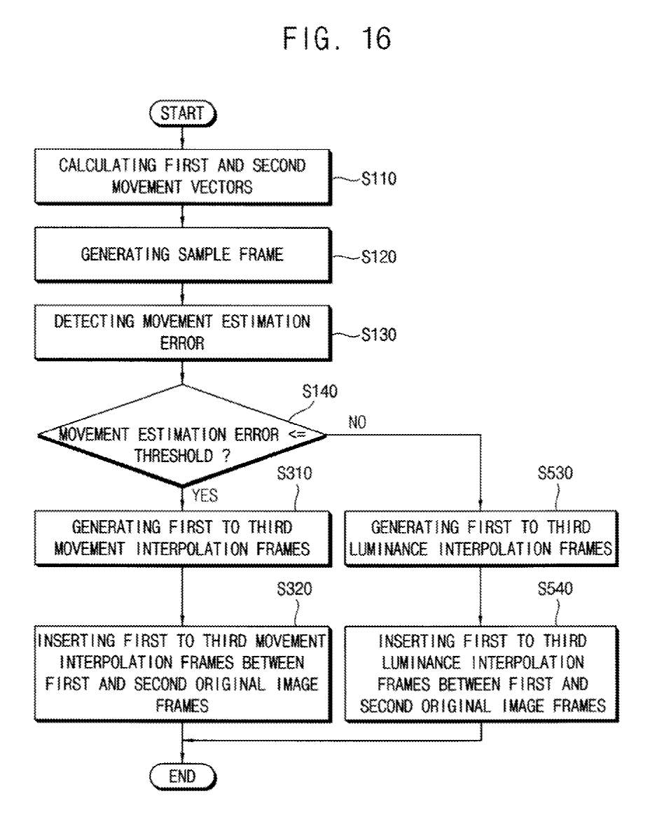

FIG. 16 is a flowchart for illustrating a driving method of the data processor of FIG. 14.

A method of driving the data processor 200d according to a present exemplary embodiment is substantially the same as a method of driving the data processor 200 according to a previous exemplary embodiment described with reference to FIGS. 8 to 10 except for steps S530 to step S540, which replace steps 330 to 350, so that the same reference numerals will be used to refer to the same or like steps as those described in a previous exemplary embodiment and thus any repetitive explanation concerning the above elements will be omitted or briefly described.

Referring to FIGS. 14 to 16, when the movement estimation error is greater than the threshold, the mode decider 217d outputs the eighth interpolating mode signal mode_8 to the movement interpolator 215d.

When the movement interpolator 215d receives the eighth interpolating mode signal mode_8, the movement interpolator 215d generates the first to third luminance interpolation frames F(G1) to F(G3) using the first and second original image frames F(A) and F(B) (step S530). Each of the first to third luminance interpolation frames F(G1) to F(G3) may have an luminance value that is an average of the first and second original image frames F(A) and F(B).

The output unit 219 sequentially inserts the first to third luminance interpolation frames F(G1) to F(G3) between the first and second original image frames F(A) and F(B) and outputs the original and the inserted frames (step S540).

According to a present exemplary embodiment, the movement interpolator 215d performs fewer calculations compared with a previous exemplary embodiments described with reference to FIGS. 8 to 10 and FIGS. 11 to 14, preventing overheating of the FRC 210d. In addition, the display of rough and jittery images caused by inserting an erroneous movement interpolation frame may be prevented.

The foregoing is illustrative of the embodiments of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. Embodiments of the present invention are defined by the following claims, with equivalents of the claims to be included therein.

What is claimed is:

1. A method of processing image data, the method comprising:
calculating first and second movement vectors by estimating data movement between differing first and second original image frames received at a first frame rate;
generating a sample frame using the first and second movement vectors;
comparing the first original image frame with the sample frame to yield a movement error estimation;
generating at least one luminance interpolation frame having a luminance value that is an average of two adjacent image frames, if the movement error estimation is greater than a preset threshold;
inserting the luminance interpolation frames between the first and second original image frames; and
outputting the original and inserted frames at a second frame rate that is greater than the first frame rate.

2. The method of claim 1, wherein the two adjacent image frames are the first and second original image frames.

3. The method of claim 2, wherein the first frame rate is about 60 Hz, and the second frame rate is about 240 Hz.

4. The method of claim 2, wherein the first frame rate is about 24 Hz, and the second frame rate is about 240 Hz.

5. The method of claim 1, further comprising:
generating at least one movement interpolation frame as a weighted average of the first and second movement vectors; and
inserting the movement interpolation frame between the first and second original image frames,
wherein the two adjacent frames are at least one of the first original image frame and one of the movement interpolation frames, adjacent movement interpolation frames, or one of the movement interpolation frames and the second original image frame.

6. The method of claim 5, wherein the first frame rate is about 60 Hz, and the second frame rate is about 240 Hz, wherein the movement interpolation frames and the luminance interpolation frames are inserted with a ratio of about 1:2 or about 2:1.

7. The method of claim 5, wherein the first frame rate is about 24 Hz, and the second frame rate is about 240 Hz, wherein the movement interpolation frames and the luminance interpolation frames are inserted with a ratio of about 4:5.

8. An image processing apparatus comprising:
a movement estimator for calculating first and second movement vectors between differing first and second original image frames received at a first frame rate;
a movement interpolator for generating a sample frame using first and second movement vectors, and for generating at least one luminance interpolation frame and at least one movement interpolation frame;
a mode decider for comparing the first original image frame with the sample frame to determine movement error estimation; and
an output unit for inserting one or more of the luminance interpolation frame and the movement interpolation frame between the first and second original image frames, based on the movement error estimation, and for outputting the first and second original image frames and the inserted frames therebetween at a second frame rate that is greater than the first frame rate.

9. The image processing apparatus of claim 8, further comprising a frame memory for storing the first original frame for comparison with the sample frame, and the second original frame for calculating the first and second movement vectors from the first and second original image frames.

10. The image processing apparatus of claim 8, wherein, if the movement error estimation is greater than a preset threshold, the two adjacent image frames are the first and second original image frames, the movement interpolator generates the luminance interpolation frame as having a luminance value that is an average of the two adjacent image frames, and the output unit inserts the luminance interpolation frame between the first and second original image frames and outputs the original and inserted frames.

11. The image processing apparatus of claim 8, wherein, if the movement error estimation is greater than a preset threshold, the movement interpolator generates at least one movement interpolation frame as a weighted average of the first and second movement vectors and generates the luminance interpolation frame as having a luminance value that is an average of the two adjacent image frames, wherein the two adjacent frames are at least one of the first original image frame and one of the movement interpolation frames, adjacent movement interpolation frames, or one of the movement interpolation frames and the second original image frame, and the output unit inserts the luminance interpolation frame and the movement interpolation frame between the first and second original image frames and outputs the original and inserted frames.

12. The image processing apparatus of claim 11, wherein the first frame rate is about 60 Hz, and the second frame rate is about 240 Hz, wherein the movement interpolation frame and the luminance interpolation frame are inserted with a ratio of about 1:2 or about 2:1.

13. The image processing apparatus of claim 11, wherein the first frame rate is about 24 Hz, and the second frame rate is about 240 Hz, wherein the movement interpolation frame and the luminance interpolation frame are inserted as a ratio of about 4:5.

14. The image processing apparatus of claim 8, wherein, if the movement error estimation is less than a preset threshold, the movement interpolator generates one or more movement interpolation frames as a weighted average of the first and second movement vectors, and the output unit inserts the movement interpolation frames between the first and second original image frames and outputs the original and inserted frames.

15. The image processing apparatus of claim 8, further comprising:
a timing controller for receiving the original and the inserted frames from the output unit, and for outputting the original and the inserted frames and a control signal;
a display panel for displaying an image; and
a panel driver for receiving the original and the inserted frames and control signal from the timing controller, converting the original and the inserted frames into analog format, and outputting the converted frames to the display panel.

16. A method of processing image data, the method comprising:
calculating first and second movement vectors by estimating data movement between differing first and second original image frames received at a first frame rate;
generating one or more movement interpolation frames calculated as a weighted average of the first and second movement vectors;
inserting the movement interpolation frames between the first and second original image frames; and
outputting the original and inserted frames at a second frame rate that is greater than the first frame rate.

17. The method of claim 16, further comprising:
generating a sample frame using the first and second movement vectors; and
comparing the first original image frame with the sample frame to yield a movement error estimation,
wherein the one or more movement interpolation frames are calculated if the movement error estimation is less than a preset threshold.

18. The method of claim 17, further comprising, if the movement error estimation is greater than a preset threshold, generating at least one luminance interpolation frame having a luminance value that is an average of two adjacent image frames, wherein the two adjacent frames are at least one of the first original image frame and one of the movement interpolation frames, adjacent movement interpolation frames, or one of the movement interpolation frames and the second original image frames.

19. The method of claim 18, wherein the first frame rate is about 60 Hz, and the second frame rate is about 240 Hz, wherein the movement interpolation frames and the luminance interpolation frames are inserted with a ratio of about 1:2 or about 2:1.

20. The method of claim 18, wherein the first frame rate is about 24 Hz, and the second frame rate is about 240 Hz, wherein the movement interpolation frames and the luminance interpolation frames are inserted with a ratio of about 4:5.
